(19) United States
(12) Patent Application Publication
(10) Pub. No.: US 2008/0270780 A1
(43) Pub. Date: Oct. 30, 2008

(54) DESIGN STRUCTURE FOR DISABLING A UNIVERSAL SERIAL BUS PORT

(76) Inventors: FERNANDO A. LOPEZ, Cary, NC (US); James R. Goffena, Chapel Hill, NC (US); Andrew S. Heinzmann, Apex, NC (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/167,526

(22) Filed: Jul. 3, 2008

Related U.S. Application Data
(63) Continuation-in-part of application No. 11/422,370, filed on Jun. 6, 2006.

(51) Int. Cl. G06F 9/00

(52) U.S. Cl. 713/1

(57) ABSTRACT

A design structure embodied in a machine readable storage medium for designing, manufacturing, and/or testing a design is disclosed for disabling a Universal Serial Bus (‘USB’) port by identifying a USB port to be disabled, the USB port to be disabled controlled by a USB hub controller, and turning on an over current signal for the identified USB port.

### CROSS-REFERENCE TO RELATED APPLICATION

This application is a continuation-in-part of co-pending U.S. patent application Ser. No. 11/422,370, filed Jun. 6, 2006, which is herein incorporated by reference.

### BACKGROUND OF THE INVENTION

1. Field of the Invention

The field of the invention is generally related to design structures, and more specifically, design structures for disabling a Universal Serial Bus port.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

The advances made by these powerful computer systems are accompanied by advances in computer bus architectures such as the introduction of the Universal Serial Bus (‘USB’). The Universal Serial Bus (‘USB’) architecture has become a standard interface technology on most types of computer systems. The USB architecture was originally developed to replace an array of legacy input/output interfaces such as, for example, the PS/2 keyboard and mouse ports, parallel ports, serial ports, and so on. Typical implementations of the USB architecture include USB port connectors on the front or back of computer systems that are easily accessible by any user.

As USB technology has evolved, computer architects are developing newer, more advanced USB devices such as, for example, external USB hard drives. Users may plug external USB hard drives into a computer system and use the devices as portable storage. In addition, leading-edge BIOS code development demonstrates that users may, in the near future, also use external USB hard drives as bootable devices. That is, a user may connect an external USB hard drive to a computer system and load an operating system from the external USB hard drive.

The ability of users to utilize an external USB hard drive as bootable device creates a broad array of security issues, especially on server systems storing sensitive data. Consider the following example where a system administrator sets up a server system and loads an operating system on one of the storage subsystem partitions. After loading the operating system, the system administrator sets up one or more additional partitions on a storage subsystem partition for data storage. The system administrator sets access controls and user permissions at the operating system level so that a user may only access data for which the user is authorized. To alter access controls and user permissions, a system administrator may log onto the server systems operating system locally using local logon passwords. Using one of the easily accessible USB ports on the server system, however, an unauthorized user may connect an external USB hard drive on which an operating system is installed to the server system. The unauthorized user may then reboot the server system to load the operating system on the USB external hard drive if permitted by the BIOS support and configuration. The unauthorized user would then have full control of the server system and full access to all sensitive data in the server storage partitions because the unauthorized user booted the server to an operating system image controlled by the unauthorized user. Bypassing the operating system installed internally on the server effectively bypasses any restrictions to the data stored on the server because all permissions and user access controls are set at the operating system level.

### SUMMARY OF THE INVENTION

Methods, apparatus, and computer program products are disclosed for disabling a Universal Serial Bus (‘USB’) port by identifying a USB port to be disabled, the USB port to be disabled controlled by a USB hub controller, and turning on an over current signal for the identified USB port.

In another embodiment, a design structure embodied in a machine readable storage medium for at least one of designing, manufacturing, and testing a design is provided. The design structure generally includes an apparatus for disabling a Universal Serial Bus (‘USB’) port. The apparatus generally includes a computer processor, and a computer memory operatively coupled to the computer processor. The computer memory may include computer program instructions disposed within it. The instructions are capable of identifying a USB port to be disabled, the USB port to be disabled controlled by a USB hub controller, and turning on an over current signal for the identified USB port.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of automated computing machinery comprising an exemplary computer useful in disabling a USB port according to embodiments of the present invention.

FIG. 2 sets forth a flow chart illustrating an exemplary method for disabling a USB port according to embodiments of the present invention.

FIG. 3 sets forth a flow chart illustrating a further exemplary method for disabling a USB port according to embodiments of the present invention.

FIG. 4 sets forth a flow chart illustrating a further exemplary method for disabling a USB port according to embodiments of the present invention.

FIG. 5 sets forth a flow chart illustrating a further exemplary method for disabling a USB port according to embodiments of the present invention.

FIG. 6 is a flow diagram of a design process used in semiconductor design, manufacture, and/or test.

### DETAILED DESCRIPTION OF EXEMPLARY EMBODIMENTS

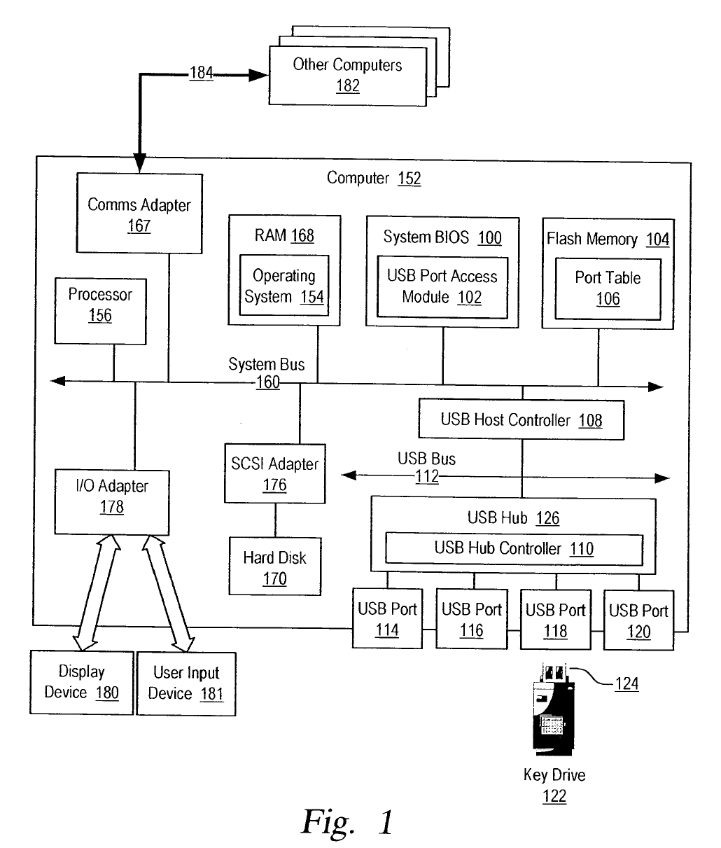

Exemplary methods, apparatus, and products for disabling a Universal Serial Bus (‘USB’) port according to embodiments of the present invention are described with reference to the accompanying drawings, beginning with FIG. 1. Disabling a USB port in accordance with the present invention is generally implemented with computers, that is, with automated computing machinery. FIG. 1, therefore, sets forth a block diagram of automated computing machinery comprising an exemplary computer (152) capable of disabling a USB port according to embodiments of the present invention. The exemplary computer (152) of FIG. 1 operates generally for disabling a USB port by identifying a USB port to be disabled, where the USB port to be disabled is controlled by a USB hub controller, and turning on an over current signal for the identified USB port. The over current signal is a signal representing that a real or simulated over current condition exists on the USB port controlled by the USB hub.

The Universal Serial Bus architecture provides a serial bus standard for connecting together devices such as, for example, computers, game consoles, personal digital assistants, televisions, stereo equipment, and so on. The Universal Serial Bus Specification Revision 2.0 (‘USB Specification’) jointly authored by Compaq, Hewlett-Packard, Intel, Lucent, Microsoft, NEC, and Philips sets forth the standard for developing USB components and communicating among the components. USB components include, for example, devices, cables, hubs, host controllers, hub controllers, ports, interfaces, and so on.

The exemplary computer (152) of FIG. 1 includes USB ports (114, 116, 118, and 120). A USB port is a point of access conforming to the USB Specification and provides a point of attachment for a USB device to the USB bus. A USB device is a logical or physical entity that performs a function according to the USB Specification. A function may include data storage, a network connection, data input, and so on. Examples of USB devices may include such devices as optical storage drives, printers, card readers, key drives, hubs, and so on.

The USB Specification provides standards for handling an over current condition on a USB port. An over current condition exists on a USB port when the USB port draws more than the maximum current permitted by the USB Specification. The USB Specification typically permits USB ports on bus-powered USB hubs to draw a maximum of 100 milliamperes, while USB ports on self-powered USB hubs are permitted to draw a maximum of 500 milliamperes. The USB Specification dictates that when an over current condition exists on a USB port, the port is to be placed in a powered-off state and data communications through the port are to be ignored. Placing a USB port in a powered-off state and ignoring data communications through the port serves to isolate the circuitry connected to the USB bus that is not operating in conformity with the USB Specification and effectively disables the USB port. Simulating or generating an over current condition on a USB port, therefore, may be useful for disabling the USB port for other reasons such as, for example, preventing devices external to a computer system from serving as boot devices.

In the example of FIG. 1, USB port (118) provides a point of attachment for a key drive (122). Key drive (122) is a small, lightweight removable data storage device that consists of a small printed circuit board encased in robust casing that makes the drive sturdy enough to be carried around. A key drive typically, but not always, uses flash memory to store data. In the example of FIG. 1, key drive employs a USB connector (124) to connect with USB port (118). In the case of USB key drives, typically only the USB connector protrudes from the protective casing, and often the USB connector is covered by a removable plastic cap.

In the example of FIG. 1, the exemplary computer (152) also includes USB host controller (108). In USB terminology, the exemplary computer (152) containing the host controller (108) is referred to as a ‘host.’ The USB host controller (108) provides an interface for other components of the exemplary computer (152) to utilize USB hubs and USB devices connected to USB ports (114, 116, 118, and 120). The USB host controller (108) may be implemented as a combination of hardware, firmware, or software.

The exemplary computer (152) of FIG. 1 also includes USB hub (126) connected to the USB host controller (108). The USB hub (126) is a device that provides USB ports (114, 116, 118, and 120) for connecting other USB devices to the USB bus (112). The USB Specification provides that multiple USB hubs may be connected together in a tree structure to support up to 127 devices. Although multiple hubs may be connected together to expand the USB bus, only one USB hub may be directly connected to the USB host controller (108). The USB hub (126) directly connected to the USB host controller (108) is referred to as the ‘root hub.’

In the example of FIG. 1, the USB hub (126) includes a USB hub controller (110). The USB hub controller (110) provides an interface for host-to-hub communication through logical channels called ‘pipes.’ These pipes are connections from the USB host controller (108) to a logical entity on a USB hub or device named an ‘endpoint.’ The USB hub controller (110) communicates hub and port configuration and control information to the USB host controller (108) through a ‘default control pipe’ connected to endpoint ‘0’ in the USB hub controller (110). The USB hub controller (110) communicates changes in the status of the hub or a port provided by the hub using the ‘status change endpoint’ periodically polled by the USB host controller (108). If changes to the status of a hub or port provided by the hub have occurred, the USB hub controller (110) notifies the USB host controller (108) of the changes by transmitting a ‘hub and port status change bitmap’ to the host controller (108) through the status change endpoint to allow the host controller (108) to take an appropriate action. By issuing hub-specific status and control commands to the host controller (108), other hardware, firmware, or software of the exemplary computer (152) may also configure, monitor, and control the USB hub (126) and the USB ports (114, 116, 118, and 120) provided by the hub. Examples of status and control commands may include, for example, ‘GetHubStatus,’ ‘GetPortStatus,’ ‘SetHubFeature,’ ‘SetPortFeature,’ and so on.

The exemplary computer (152) also includes system BIOS (100). The term ‘BIOS’ stands for ‘Basic Input/Output System.’ The system BIOS (100) is firmware that initializes and tests the hardware components of the computer as well as loads, executes, and passes control of computer hardware components over to an operating system. The system BIOS typically remains in use after the operating system loads to provide the operating system low-level access to certain computer hardware devices.

In the exemplary computer (152), system BIOS (100) includes a USB port access module (102). The USB port access module (102) is a set of computer program instructions improved for disabling a USB port according to embodiments of the present invention. The USB port access module (102) operates generally for disabling a USB port according to embodiments of the present invention by identifying a USB port to be disabled, where the USB port to be disabled is controlled by a USB hub controller, and turning on an over current signal for the identified USB port.

The exemplary computer (152) also includes electrically erasable programmable read-only memory (so-called ‘EEPROM’ or ‘Flash’ memory) (104) having stored upon it a port table (106). The port table (106) contains data representing the USB ports (114, 116, 118, and 120) of the exemplary computer (152). The port table (106) contains information useful for disabling a USB port according to embodiments of the present invention such as, for example, the identity of a USB port to be disabled.

The exemplary computer (152) of FIG. 1 includes at least one computer processor (156) or ‘CPU’ as well as random access memory (168) (‘RAM’) which is connected through a system bus (160) to processor (156) and to other components of the computer. Stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. The operating system (154) in the example of FIG. 1 is shown in RAM (168), but many components of such software typically are stored in non-volatile memory such as hard disk (170), flash memory (104), RAM drives (not shown), or as any other kind of non-volatile computer memory as will occur to those of skill in the art.

The exemplary computer (152) of FIG. 1 also includes a Small Computer System Interface (‘SCSI’) adapter (176) connected to processor (156) and the other components of the computer (152) through system bus (160). SCSI is a standard bus protocol for transferring data between a variety of devices on both internal and external computer buses issued by the InterNational Committee for Information Technology Standards (‘INCITS’). Several varieties of the SCSI standard exist such as, for example, SCSI-1, SCSI-2, SCSI-3, Ultra SCSI, Wide SCSI, and so on. The SCSI adapter (176) provides an interface for other components of computer (152) to utilize SCSI hard disk drive (170).

The exemplary computer of FIG. 1 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 1 includes a communications adapter (167) for implementing data communications (184) with other computers (182). Such data communications may be carried out serially through RS-232 connections, through external buses such as USB, through data communications networks such as Internet Protocol (‘IP’) networks, and in other ways as will occur to those of skill in the art. Communications adapters implement the hardware level of data communications through which one computer sends data communications to another computer, directly or through a network. Examples of communications adapters useful for disabling a USB port according to embodiments of the present invention include modems for wired dial-up communications, Ethernet (IEEE 802.3) adapters for wired network communications, and 802.11b adapters for wireless network communications.

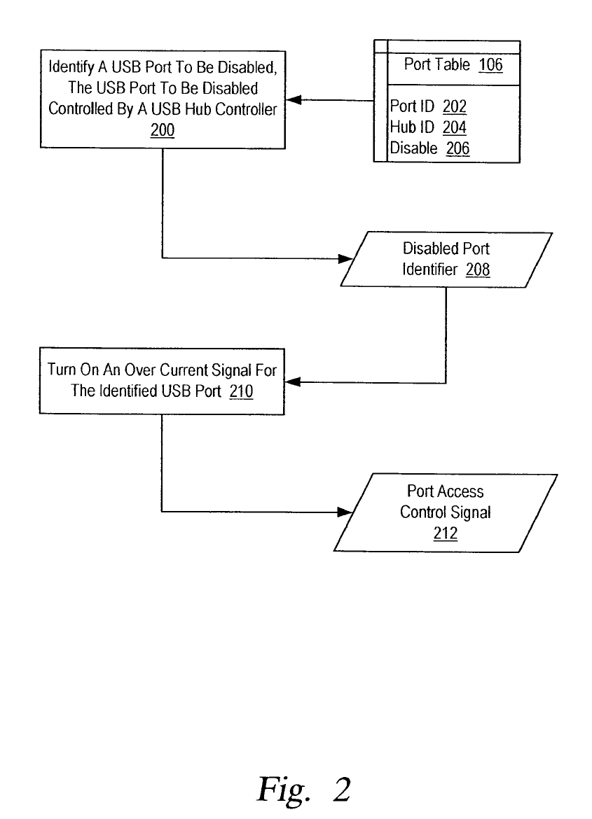

For further explanation, FIG. 2 sets forth a flow chart illustrating an exemplary method for disabling a USB port according to embodiments of the present invention that includes identifying (200) a USB port to be disabled, where the USB port to be disabled is controlled by a USB hub controller, and turning on (210) an over current signal for the identified USB port. Identifying (200) a USB port to be disabled according to the method of FIG. 2 may be carried out by retrieving a port ID (202) identifying the USB port to be disabled from a port table (106). The exemplary port table (106) of FIG. 2 is a data structure that stores data representing USB ports connected to a USB bus of a computer system. The port table (106) associates a port identifier (202) with a hub identifier (204) and a disable indicator (206). The port identifier (202) represents a particular USB port connected to the USB bus of a computer system. The hub identifier (204) represents the USB hub providing the USB port identified by the associated port identifier (202). The disable indicator (206) represents whether or not to disable the USB port identified by the associated port identifier (202) to prevent access to the computer system by a USB device.

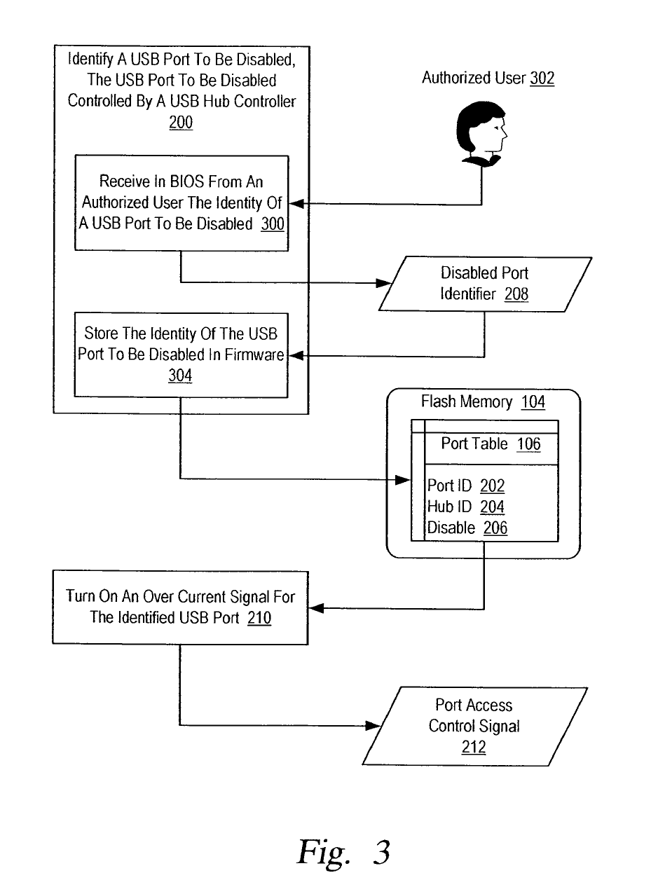

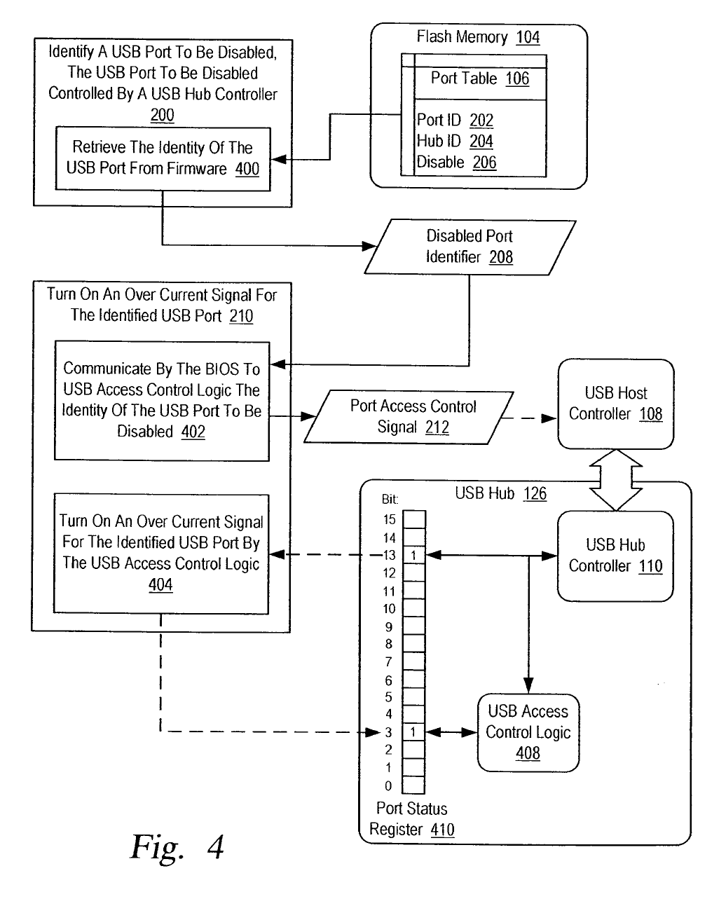

In the method of FIG. 2, identifying (200) a USB port to be disabled, where the USB port to be disabled is controlled by a USB hub controller, may be carried out by receiving in BIOS from an authorized user the identity of a USB port to be disabled, storing the identity of the USB port to be disable in firmware, or retrieving the identity of the USB port from firmware as described below with reference to FIGS. 3 and 4. In the example of FIG. 2, disabled port identifier (208) represents the identity a USB port to be disabled.

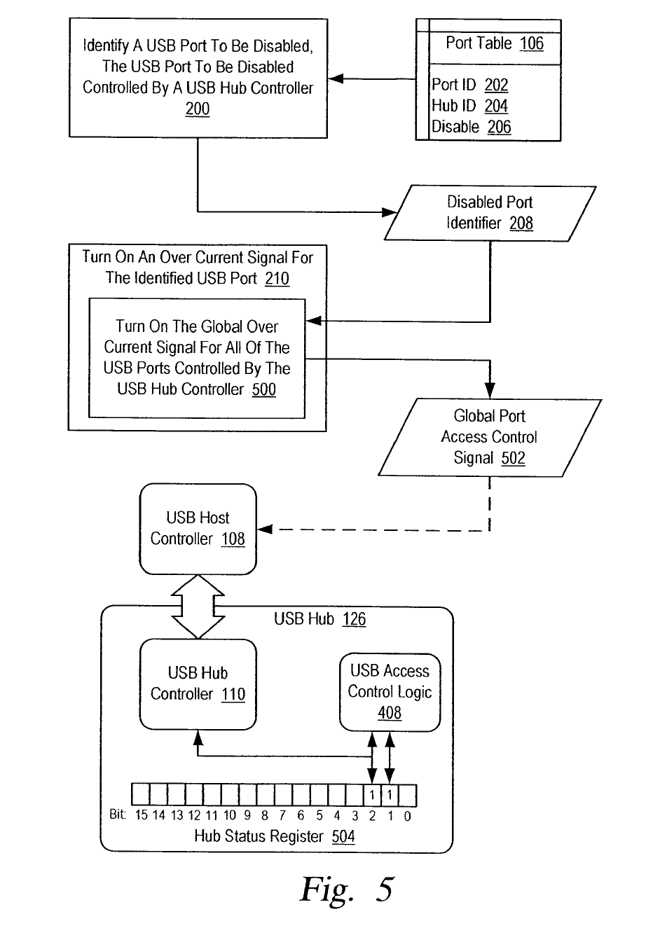

In the method of FIG. 2, turning on (210) an over current signal for the identified USB port may be carried out by communicating by a BIOS to USB access control logic the identity of the USB port to be disabled, turning on an over current signal for the identified USB port by the USB access control logic, turning on the individual over current signal for the USB port to be disabled, or turning on the global over current signal for all of the USB ports controlled by the USB hub controller as discussed below with reference to FIGS. 4 and 5. In the example of FIG. 2, port access control signal (212) represents a control signal indicating that the over current signal of a USB port to be disabled should be turned on.

As mentioned above, identifying a USB port to be disabled where the USB port to be disabled is controlled by a USB hub controller may be carried out by receiving in BIOS from an authorized user the identity of a USB port to be disabled and storing the identity of the USB port to be disabled in firmware. For further explanation, therefore, FIG. 3 sets forth a flow chart illustrating a further exemplary method for disabling a USB port according to embodiments of the present invention that includes receiving (300) in BIOS from an authorized user (302) the identity of a USB port to be disabled and storing (304) the identity of the USB port to be disabled in firmware.

The method of FIG. 3 is similar to the method of FIG. 2 in that disabling a USB port according to the method of FIG. 3 includes identifying (200) a USB port to be disabled where the USB port to be disabled is controlled by a USB hub controller and turning on (210) an over current signal for the identified USB port. In the method of FIG. 3, identifying (200) a USB port to be disabled where the USB port to be disabled is controlled by a USB hub controller includes receiving (300) in BIOS from an authorized user (302) the identity of a USB port to be disabled and storing (304) the identity of the USB port to be disabled in firmware. An authorized user (302) represents a user, such as, for example, a system administrator, authorized to identify a USB port to be disabled. The authorized user (302) may obtain authorization to identify a USB port to be disabled by providing when prompted a username and password, a security token such as, for example, a radio frequency identification badge, biometric identification, or any other method of authorizing a user as will occur to those of skill in the art.

In the method of FIG. 3, receiving (300) in BIOS from an authorized user (302) the identity of a USB port to be disabled may be carried out by providing a list of USB ports for a computer system to a user through a user interface and receiving an indication from the user representing a port to be disabled. The user interface may be a sophisticated graphical user interface (‘GUI’) or, as is typically the case in BIOS, a crude text-based user interface. Readers will recall from above that the disabled port identifier (208) represents the identity a USB port to be disabled. Providing a list of USB ports for the computer system to a user through a graphical user interface (‘GUI’) may be carried out by obtaining the configuration of the USB ports for a computer system from a configuration file stored in non-volatile computer memory.

When such USB port configuration data for a computer system is not available, providing a list of USB ports for the computer system to a user through a user interface may be carried out by polling each USB hub for a computer system to determine the configuration of the USB ports provided by each USB hub. Polling each USB hub of a computer system may be carried out by communicating with a USB host controller according to the Open Host Controller Interface (‘OHCI’) specification developed by Compaq, Microsoft, and National Semiconductor to implement the ‘GetHubDescriptor’ command of the USB Specification. The ‘GetHubDescriptor’ command returns the USB hub descriptor data structure that provides information relating to a particular USB hub such as the number of ports provided by the hub, the logical power switching mode of the hub, over current protection mode of the hub, maximum current requirements, and so on.

As mentioned above, identifying (200) a USB port to be disabled where the USB port to be disabled is controlled by a USB hub controller according to the method of FIG. 3 includes storing (304) the identity of the USB port to be disabled in firmware. Firmware is computer program instructions embedded in computer hardware such as, for example, flash memory (104). In the example of FIG. 3, the port table (106) exists in flash memory (104). Storing (304) the identity of the USB port to be disable in firmware according to the method of FIG. 3 may, therefore, be carried out by storing, in the disable indicator (206) associated with the port identifier (202) matching the disabled port identifier (208), a value representing that the port identified by port identifier (202) is to be disabled. Readers will recall from above that the disable indicator (206) represents whether or not to disable the USB port identified by the associated port identifier (202) to prevent access to the computer system by a USB device. A value of ‘TRUE’ for the disable indicator (206) may represent that the port identified by the associated port identifier (202) is to be disabled. A value of ‘FALSE’ for the disable indicator (206) may represent that the port identified by the associated port identifier (202) is not to be disabled.

Readers will note that in the method of FIG. 3, the identity of the USB port to be disabled is provided by an authorized user (302). As mentioned above, however, identifying a USB port to be disabled may be carried out by retrieving the identity of the USB port from firmware. For further explanation, therefore, FIG. 4 sets forth a flow chart illustrating a further exemplary method for disabling a USB port according to embodiments of the present invention that includes retrieving (400) the identity of the USB port from firmware.

The method of FIG. 4 is similar to the method of FIG. 2 in that disabling a USB port according to the method of FIG. 4 includes identifying (200) a USB port to be disabled where the USB port to be disabled is controlled by a USB hub controller and turning on (210) an over current signal for the identified USB port. In the method of FIG. 4, identifying (200) a USB port to be disabled where the USB port to be disabled is controlled by a USB hub controller includes retrieving (400) the identity of the USB port from firmware. Retrieving (400) the identity of the USB port from firmware may be carried out by storing, in the disabled port identifier (208), the port identifier (202) associated with a disable indicator (206) having a value of ‘TRUE.’ As mentioned above, a value of ‘TRUE’ for the disable indicator (206) may represent that the port identified by the associated port identifier (202) is to be disabled.

In the method of FIG. 4, turning on (210) an over current signal for the identified USB port includes communicating (402) by a BIOS to USB access control logic (408) the identity of the USB port to be disabled. Communicating (402) by a BIOS to USB access control logic (408) the identity of the USB port to be disabled according to the method of FIG. 4 may be carried out by communicating a port access control signal (212) to a USB host controller (108) according to the Open Host Controller Interface (‘OHCI’) specification developed by Compaq, Microsoft, and National Semiconductor. An example of a port access control signal (212) useful in disabling a USB port according to embodiments of the present invention may include the following command from the USB Specification:
‘SetPortFeature,’ which sets values reported in a USB port's port status register.

The exemplary port access control signal (212) above initiates a communications sequence between the USB host controller (108) and the USB hub controller (110) to access a port status register (410) of the USB port to be disabled. The port status register (410) is a 16-bit register in the USB hub (126) for a particular USB port that stores data representing various attributes of the particular USB port. The USB Specification describes the port status register (410) as the ‘wPortStatus’ field. Attributes of a USB port represented in the port status register (410) may include the current connection status of the port, whether the port is enabled or disabled, whether the USB device connected to the port is suspended, whether an over current condition exists on the port, and so on. As described in the USB Specification, bits 5-7 and bits 13-15 of the port status register (410) are not utilized in current implementations of a USB hub. Using the exemplary port access control signal (212) above, communicating (402) by a BIOS to USB access control logic (408) the identity of the USB port to be disabled may, therefore, be carried out by setting bit ‘13’ in the port status register (410). In the example of FIG. 4, setting bit ‘13’ in the port status register (410) alerts USB access control logic (408) that the USB port is to be disabled. USB access control logic (408) may be implemented as, for example, a programmable logic device.

In the method of FIG. 4, turning on (210) an over current signal for the identified USB port includes turning on (404) an over current signal for the identified USB port by the USB access control logic (408). Turning on (404) an over current signal for the identified USB port by the USB access control logic (408) may be carried out by setting bit ‘3’ in the port status register (410). Bit ‘3’ in the port status register (410) represents whether an over current condition exists on the USB port of the port status register (410). Setting bit ‘3’ in the port status register (410) according to embodiments of the present invention simulates that the port draws more than the maximum current permitted for a particular USB hub configuration described in the USB Specification. The USB Specification typically permits USB ports on bus-powered USB hubs to draw a maximum of 100 milliamperes, while USB ports on self-powered USB hubs are permitted to draw a maximum of 500 milliamperes.

When the USB access control logic (408) sets bit ‘3’ in the port status register (410), the typical USB functionality described in the USB Specification operates to disable the USB port. Setting bit ‘3’ in the port status register (410) sets bit ‘3’ in the port status change register (not shown) described as the ‘wPortChange’ field in the USB Specification. Setting bit ‘3’ in the port status change register modifies a bitmap (not shown) referred to as the ‘hub and port change bitmap’ that indicates whether a hub or a port of the hub has experienced a status change. When polled by the USB host controller (108), the USB hub controller (110) returns the ‘hub and port status bitmap’ that informs the USB host controller (108) that a change on the USB port has occurred. The USB host controller (108) then requests the port status register (410) of the USB port from the USB hub controller (110). From the port status register (410), the USB host controller (110) determines that an over current condition exists on the USB port. The USB host controller (108), therefore, no longer accepts data communications through the USB port having the over current condition and issues a command to the USB hub controller (110) to place the USB port in a powered-off state. The USB hub controller (110) places the USB port in a powered-off state by resetting bit ‘8’ in the port status register (410). The USB port remains in the powered-off state until the power is cycled to the USB port.

Power may be cycled to the USB port when an authorized user no longer identifies a USB port as a port to be disabled. When an authorized user no longer identifies a USB port as a port to be disabled, a control signal may be issued to the USB host controller (108) to reset bit ‘13’ of the port status register (410). The USB access control logic (408) monitoring the port status register (410) then identifies that the USB port is no longer identified as a port to be disabled. The USB access control logic (408), therefore, no longer provides the over current signal in bit ‘3’ of the port status register (410), and the typical USB functionality described in the USB Specification operates to enable the USB port.

Readers will note that in the method of FIG. 4, the USB hub controller has an individual over current signal for each USB port controlled by the USB hub controller. Turning on the over current signal for the identified USB port according to the method of FIG. 4, therefore, is carried out by turning on an individual over current signal for the USB port to be disabled. Often, however, a USB hub controller has a global over current signal for all of the USB ports controlled by the USB hub controller. A global over current signal is a signal representing that a real or simulated over current condition exists on a USB hub. A USB hub controller may, for example, have a global over current signal because a USB hub controller aggregates ports together to control the ports in ‘gangs’ or because the USB hub controller monitors current at a hub-level granularity and not on a port-level granularity. Turning on the over current signal for the identified USB port, therefore, may be carried out by turning on a global over current signal for all of the USB ports controlled by a USB hub controller. For further explanation, FIG. 5 sets forth a flow chart illustrating a further exemplary method for disabling a USB port according to embodiments of the present invention that includes turning on (500) the global over current signal for all of the USB ports controlled by the USB hub controller (110).

The method of FIG. 5 is similar to the method of FIG. 2 in that disabling a USB port according to the method of FIG. 5 includes identifying (200) a USB port to be disabled where the USB port to be disabled is controlled by a USB hub controller and turning on (210) an over current signal for the identified USB port. In the method of FIG. 5, however, turning on the over current signal for the identified USB port includes turning on (500) a global over current signal for all of the USB ports controlled by the USB hub controller (110). Turning on (500) a global over current signal for all of the USB ports controlled by the USB hub controller (110) may be carried out by communicating a global port access control signal (502) to a USB host controller (108). The global port access control signal (502) represents a control signal indicating that the global over current signal for all of the USB ports controlled by the USB hub controller should be turned on. Communicating a global port access control signal (502) to a USB host controller (108) may be carried out by communicating with a USB host controller according to the Open Host Controller Interface (‘OHCI’) specification developed by Compaq, Microsoft, and National Semiconductor to implement the following command from the USB Specification:
‘SetHubFeature,’ which sets values reported in a USB hub's hub status register.

The exemplary global port access control signal (502) above initiates a communications sequence between the USB host controller (108) and the USB hub controller (110) to access a hub status register (504) of the USB hub controlling the USB ports to be disabled. The hub status register (504) is a 16-bit register in the USB hub (126) for a particular USB hub that stores data representing various attributes of the particular USB hub. The USB Specification describes the hub status register (504) as the ‘wHubStatus’ field. Attributes of a USB hub represented in the hub status register (504) may include whether the hub is powered by a local power supply or whether an over current condition exists on the hub. As described in the USB Specification, bits 2-15 of the hub status register (504) are not utilized in current implementations of a USB hub. Using the exemplary global port access control signal (502) above, turning on (500) a global over current signal for all of the USB ports controlled by the USB hub controller (110) may, therefore, be carried out by setting bit ‘2’ in the hub status register (504).

In the example of FIG. 5, setting bit ‘2’ in the hub status register (504) alerts USB access control logic (408) that the global over current signal for the USB hub is to be turned on. The USB access control logic (408), therefore, sets bit ‘1’ of the hub status register (504). Bit ‘1’ in the hub status register (504) represents whether an over current condition exists on the USB port of the hub status register (504). Setting bit ‘1’ in the hub status register (504) according to embodiments of the present invention simulates that the hub draws more than the maximum current permitted as described in the USB Specification. The USB Specification permits bus-powered USB hubs to draw a maximum of 500 milliamperes, while self-powered USB hubs are permitted to draw a maximum of 100 milliamperes.

When the USB access control logic (408) sets bit ‘1’ in the hub status register (504), the typical USB functionality described in the USB Specification operates to disable all the ports provided by the USB hub. Setting bit ‘1’ in the hub status register (504) sets bit ‘1’ in the hub status change register (not shown) described as the ‘wHubChange’ field in the USB Specification. Setting bit ‘1’ in the hub status change register modifies the ‘hub and port change bitmap’ (not shown) to indicate that the hub has experienced a status change. When polled by the USB host controller (108), the USB hub controller (110) returns the ‘hub and port status bitmap’ that informs the USB host controller (108) that a change on the USB hub has occurred. The USB host controller (108) then requests the hub status register (504) of the USB hub from the USB hub controller (110). From the hub status register (504), the USB host controller (110) determines that an over current condition exists on the USB hub. The USB host controller (108), therefore, no longer accepts data communications through the USB ports provided by the USB hub (126) and issues a command to the USB hub controller (110) to place all of the USB ports controlled by the hub controller (110) in a powered-off state. The USB hub controller (110) places the USB ports in a powered-off state by resetting bit ‘8’ in the port status register for each port. The USB ports remains in the powered-off state until the power is cycled to the ports.

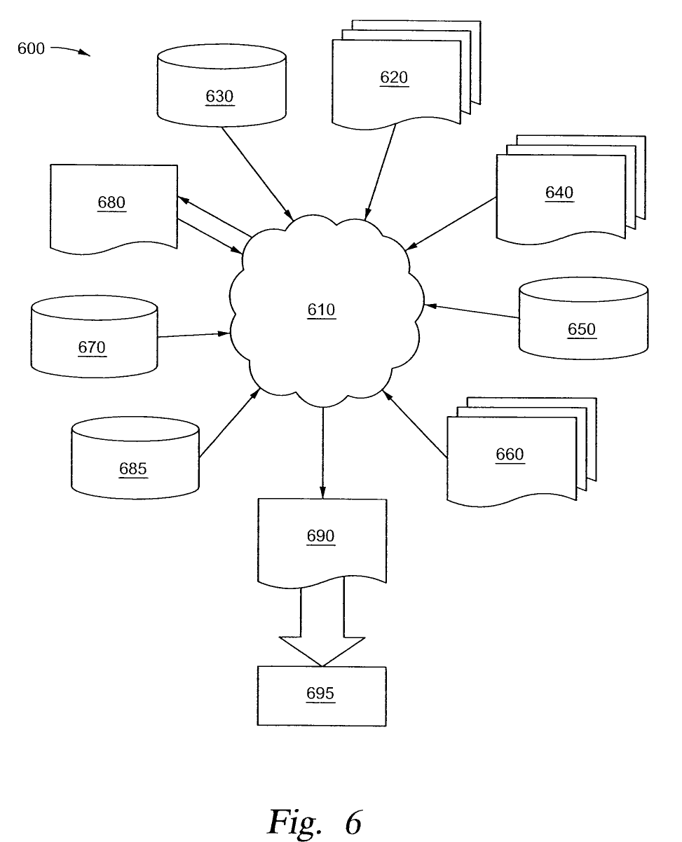

FIG. 6 shows a block diagram of an exemplary design flow (600) used for example, in semiconductor design, manufacturing, and/or test. Design flow (600) may vary depending on the type of IC being designed. For example, a design flow (600) for building an application specific IC (ASIC) may differ from a design flow (600) for designing a standard component. Design structure (620) is preferably an input to a design process (610) and may come from an IP provider, a core developer, or other design company or may be generated by the operator of the design flow, or from other sources. Design structure (620) comprises the circuit described above and shown in FIG. 1 in the form of schematics or HDL, a hardware-description language (e.g., Verilog, VHDL, C, etc.). Design structure (620) may be contained on one or more machine readable medium. For example, design structure (620) may be a text file or a graphical representation of a circuit as described above and shown in FIG. 1. Design process (610) preferably synthesizes (or translates) the circuit described above and shown in FIG. 1 into a netlist 680, where netlist (680) is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. The medium may also be a packet of data to be sent via the Internet, or other networking suitable means. The synthesis may be an iterative process in which netlist (680) is resynthesized one or more times depending on design specifications and parameters for the circuit.

Design process (610) may include using a variety of inputs; for example, inputs from library elements (630) which may house a set of commonly used elements, circuits, and devices, including models, layouts, and symbolic representations, for a given manufacturing technology (e.g., different technology nodes, 32 nm, 45 nm, 90 nm, etc.), design specifications (640), characterization data (650), verification data (660), design rules (670), and test data files (685) (which may include test patterns and other testing information). Design process (610) may further include, for example, standard circuit design processes such as timing analysis, verification, design rule checking, place and route operations, etc. One of ordinary skill in the art of integrated circuit design can appreciate the extent of possible electronic design automation tools and applications used in design process (610) without deviating from the scope and spirit of the invention. The design structure of the invention is not limited to any specific design flow.

Design process (610) preferably translates a circuit as described above and shown in FIG. 1, along with any additional integrated circuit design or data (if applicable), into a second design structure (690). Design structure (690) resides on a storage medium in a data format used for the exchange of layout data of integrated circuits (e.g. information stored in a GDSII (GDS2), GL1, OASIS, or any other suitable format for storing such design structures). Design structure (690) may comprise information such as, for example, test data files, design content files, manufacturing data, layout parameters, wires, levels of metal, vias, shapes, data for routing through the manufacturing line, and any other data required by a semiconductor manufacturer to produce a circuit as described above and shown in FIG. 1. Design structure (690) may then proceed to a stage (695) where, for example, design structure (690): proceeds to tape-out, is released to manufacturing, is released to a mask house, is sent to another design house, is sent back to the customer, etc.

Exemplary embodiments of the present invention are described largely in the context of a fully functional computer system for disabling a USB port. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A design structure embodied in a machine readable storage medium for at least one of designing, manufacturing, and testing a design, the design structure comprising:
an apparatus for disabling a Universal Serial Bus (‘USB’) port, the apparatus comprising a computer processor, a computer memory operatively coupled to the computer processor, the computer memory having disposed within it computer program instructions capable of:
identifying a USB port to be disabled, the USB port to be disabled controlled by a USB hub controller; and
turning on an over current signal for the identified USB port.

2. The design structure of claim 1, wherein turning on the over current signal for the identified USB port further comprises:
communicating by a BIOS to USB access control logic the identity of the USB port to be disabled; and
turning on an over current signal for the identified USB port by the USB access control logic.

3. The design structure of claim 1, wherein identifying the USB port to be disabled further comprises:
receiving in BIOS from an authorized user the identity of a USB port to be disabled; and
storing the identity of the USB port to be disabled in firmware.

4. The design structure of claim 1 wherein:
the USB hub controller has an individual over current signal for each USB port controlled by the USB hub controller, and
turning on the over current signal for the identified USB port further comprises turning on the individual over current signal for the USB port to be disabled.

5. The design structure of claim 1 wherein:
the USB hub controller has a global over current signal for all of the USB ports controlled by the USB hub controller, and
turning on the over current signal for the identified USB port further comprises turning on the global over current signal for all of the USB ports controlled by the USB hub controller.

6. The design structure of claim 1 wherein identifying the USB port to be disabled further comprises retrieving the identity of the USB port from firmware.

7. The design structure of claim 1, wherein the design structure comprises a netlist, which describes the apparatus.

8. The design structure of claim 1, wherein the design structure resides on the machine readable storage medium as a data format used for the exchange of layout data of integrated circuits.
